(19) United States
(12) Patent Application Publication
(10) Pub. No.: US 2007/0005256 A1
(43) Pub. Date: Jan. 4, 2007

(54) Method and apparatus for real-time correlation of data collected from biological sensors

(76) Inventors: Patrick Dennis Lincoln, Woodside, CA (US); Alfonso De Jesus Valdes, San Carlos, CA (US); Phillip Andrew Porras, Mountain View, CA (US)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 11/073,257

(22) Filed: Mar. 4, 2005

Related U.S. Application Data
(60) Provisional application No. 60/550,472, filed on Mar. 4, 2004.

(51) Int. Cl. G06F 19/00

(52) U.S. Cl. 702/19

(57) ABSTRACT

A method and apparatus are provided for performing real-time correlation of data collected from biological sensors, including, but not limited to, sensors adapted to analyze biological material (e.g., blood or tissue samples) and environmental material (e.g., air or water samples). In one embodiment, a method for correlating biological data over a broad (geographic or demographic) domain includes receiving data relating to at least two samples of biological material, where the samples originate at two different regions of the broad domain. This data is then correlated to produce a domain-wide view of the biological data, thereby enabling the rapid identification of domain-wide medical emergencies. Moreover, this correlated information may be provided to lower-level correlation sources or to the biological sensors in order to increase the sensitivities of the correlation sources or biological sensors to emerging threats.

### CROSS REFERENCE TO RELATED APPLICATIONS

This application claims the benefit of U.S. Provisional Patent Application Ser. No. 60/550,472, filed Mar. 4, 2004 (titled “Hierarchical Analysis and Correlation of Biological Sensors”), which is herein incorporated by reference in its entirety.

### FIELD OF THE INVENTION

The present invention relates generally to the analysis of data collected from biological sensors and relates more specifically to the correlation of output from multiple biological sensors to detect the presence of biological agents (e.g., pathogens and toxic agents).

### BACKGROUND OF THE DISCLOSURE

In a clinical setting, a description of symptoms alone typically does not provide enough information to diagnose between two or more similar illnesses in a potentially stricken individual. However, an accurate diagnosis is vital, as a misdiagnosis could cause more harm to the individual and could even allow a contagion to spread. Thus, there has long been a need for a device that can analyze a small sample of biological material (e.g., tissue, blood, other fluids and the like) taken from an individual and quickly provide an accurate diagnosis.

Recent advances have provided various forms of biological sensors that can detect pathogens and toxic agents, ranging from very specific sensors capable of detecting particular pathogens or toxic agents to more general sensors that detect the mere presence (but not the identity) of a pathogen or toxic agent. Such sensors typically produce very complex results, including probability measures and time series results, which must subsequently be analyzed and interpreted.

Where multiple biological sensors are deployed to detect a particular pathogen or toxic agent, each sensor often analyzes different aspects of a sample (e.g., different segments of DNA). Though none of these sensors operating alone can produce sufficient evidence to make a determination, such evidence may be provided by the multiple sensors operating in collaboration.

Clinical staffs are thus presented with a large volume of complex and highly technical raw sensor data on which to base a diagnosis. Moreover, because systems for deploying sensors tend to be localized, it may be difficult to detect when sensor results may be indicative of a more widespread epidemic. In emergency situations (e.g., involving fast-spreading or potentially serious illnesses), these realities impede the ability of clinical staff to respond to such occurrences in an appropriately timely manner.

Thus, there is a need in the art for a method and apparatus for real-time correlation of data collected from biological sensors.

### SUMMARY OF THE INVENTION

A method and apparatus are provided for performing real-time correlation of data collected from biological sensors, including, but not limited to, sensors adapted to analyze biological material (e.g., blood or tissue samples) and environmental material (e.g., air or water samples). In one embodiment, a method for correlating biological data over a broad (geographic or demographic) domain includes receiving data relating to at least two samples of biological material, where the samples originate at two different regions of the broad domain. This data is then correlated to produce a domain-wide view of the biological data, thereby enabling the rapid identification of domain-wide medical emergencies. Moreover, this correlated information may be provided to lower-level correlation sources or to the biological sensors in order to increase the sensitivities of the correlation sources or biological sensors to emerging threats.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating a system for reporting and correlating biological sensor data in accordance with the present invention;

FIG. 2 illustrates a flow diagram of one embodiment of a method for analyzing and correlating sensor results for execution by the system illustrated in FIG. 1, according to the present invention;

FIG. 3 is a plan view illustrating one embodiment of an array of biological sensors that may be adapted for use with the system illustrated in FIG. 1;

FIG. 4 is a schematic diagram illustrating one embodiment of a distributed correlation node that may be adapted for use with the system illustrated in FIG. 1;

FIG. 5 is a flow diagram illustrating one embodiment of an adaptive learning method that may be implemented in one or more analysis components illustrated in FIG. 4; and

FIG. 6 is a high level block diagram of the present method for correlation of biological sensors that is implemented using a general purpose computing device.

To facilitate understanding, identical reference numerals have been used, where possible, to designate identical elements that are common to the figures.

### DETAILED DESCRIPTION

The present invention relates to a method and apparatus for real-time correlation of data collected from biological sensors, where the biological sensors include, but are not limited to, sensors capable of analyzing biological (e.g., bodily fluids, tissue, etc.) and/or environmental (e.g., air, water, etc.) samples for signs of pathogens and/or toxic agents. The invention facilitates the rapid detection and identification of biological agents within samples of biological or environmental material, thereby enabling clinicians and health care providers to accurately identify pathogens and toxic agents present in an individual, in multiple individuals or in the environment and to respond to potentially serious and/or fast-spreading illnesses in a timely manner.

Within the context of the present invention, the terms “pathogens” and “toxic agents” refer to any agents that cause disease in living organisms, e.g., common disease-causing agents and biowarfare agents, including, but not limited to Category A, B and C agents/diseases as set forth by the Centers for Disease Control, such as Bacillus anthracis, Clostridium botulinum toxin, Yersinia pestis, Smallpox (variola major), Tularemia (Francisella tularensis), Viral hemorrhagic fevers (filoviruses [e.g., Ebola, Marburg] and arenaviruses [e.g., Lassa, Machupo]), Brucellosis (Brucella species), Epsilon toxin of Clostridium perfringens, Salmonella species, Escherichia coli O157:H7, Shigella, Glanders (Burkholderia mallei), Melioidosis (Burkholderia pseudomallei), Psittacosis (Chlamydia psittaci), Q fever (Coxiella burnetii), Ricin toxin from Ricinus communis (castor beans), Staphylococcal enterotoxin B, Typhus fever (Rickettsia prowazekii), Viral encephalitis (alphaviruses [e.g., Venezuelan equine encephalitis, eastern equine encephalitis, western equine encephalitis]), Vibrio cholerae, Cryptosporidium parvum, Vibrio cholerae, and Cryptosporidium parvum, as well as venereal diseases).

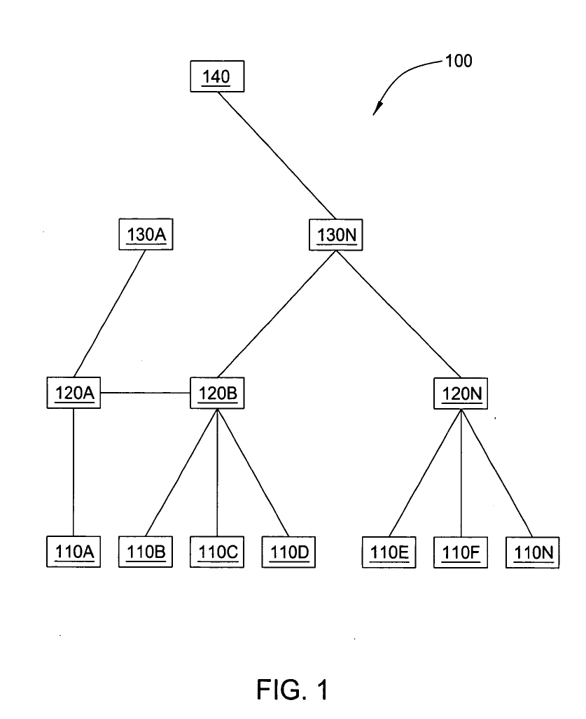

FIG. 1 is a schematic diagram illustrating a system 100 for reporting and correlating biological sensor data in accordance with the present invention. The system 100 comprises a plurality of sensors or sensor arrays 110a-110n (hereinafter collectively referred to as “sensors 110”), a plurality of local distributed correlation nodes 120a-120n (hereinafter collectively referred to as “local nodes 120”), a plurality of intermediate or regional distributed correlation nodes 130a-130n (hereinafter collectively referred to as “regional nodes 130”) and one or more global distributed correlation nodes 140. In one embodiment, each of the sensors 110 is in communication with (e.g., via encrypted communication links) one or more local nodes 120. Furthermore, one or more of the local nodes 120 is in communication with one or more regional nodes 130, and one or more of the regional nodes 130 is in communication with the global node 140. In addition, nodes on common levels may communicate with each other (e.g., local nodes 120 may communicate with other local nodes 120; regional nodes 130 may communicate with other regional nodes 130; etc.). Alternatively, in some embodiments, the sensors 110 may communicate directly with the global node 140.

In one embodiment, each local node 120 may represent, for example a hospital or health care agency; each regional node 130 may represent, for example, a county or state; and global node 140 may represent, for example, an entire country or a group of countries, so that a hierarchical reporting structure is formed. Although the system 100 is illustrated as having three hierarchical reporting levels (e.g., local, regional and global), those skilled in the art will appreciate that the system 100 may implement any number of reporting levels having any number of nodes or sensors within each level. Moreover, sensors and/or nodes may be dynamically added or removed at any level. Furthermore, although the system 100 is illustrated as having a strict hierarchical structure, those skilled in the art will appreciate that any intermediate node (e.g., local nodes 120 or regional nodes 130) may report to more than one higher-level node (e.g., regional nodes 130 or global node 140).

In one embodiment, local and regional nodes 120 and 130 are configured to perform correlated analysis over all or part of a domain, which may be a geographic region, a political region or other grouping of sensors 110 that is required for a particular care-giver or decision maker. Local and regional nodes 120 and 130 thereby are enabled to provide a domain-wide perspective of activity or patterns with respect to biological pathogens, toxic agents and contagions. In one embodiment, local and regional nodes 120 and 130 are further enabled to reconfigure system parameters of other nodes, interface with other nodes or monitors outside of the domain and report activity within the domain to domain administrators. In one embodiment, local and regional nodes 120 and 130 can subscribe to reports from both the sensors 110 and from other local and regional nodes 120 and 130. In one embodiment, local and regional nodes 120 and 130 establish peer-to-peer relationships to enable the share of reports, including reports produced in other domains. In one embodiment, local and regional nodes 120 and 130 implement one or more analysis reports, as described in further detail below, to dynamically adjust the sensitivity of the analysis and correlation performed by the sensors 110, the local nodes 120, the regional nodes 130 or a combination thereof, e.g., in order to enhance detection of activity that has been observed in one or more domains.

In one embodiment, global node 140 is configured to receive data from local and/or regional nodes 120, 130 in order to perform correlated analysis over a set of monitored domains, thereby providing a single, coordinated view of activity within one or more domains monitored by local and regional nodes 120 and 130. The global node 140 thus provides a coordinated view of the observations of the sensors 110. In one embodiment, a plurality of global nodes 140 are deployed in order to provide a backup in the event of node or communication link failure.

In one embodiment, the global node 140 is enabled to reconfigure the system parameters of other nodes (e.g., local and regional nodes 120 and 130), to interface with other global nodes 140 and to report observed activity or patterns to system administrators. In one embodiment, the global node 140 can subscribe to reports from sensors 110 and from local and regional nodes 120 and 130, as well as from other global nodes 140. In one embodiment, multiple global nodes 140 establish a peer-to-peer relationship among each other for the sharing or reports. In one embodiment, the global node 140 uses received reports to dynamically adjust the sensitivity of analysis and correlation procedures performed by the global node 140, the local and regional nodes 130 and 130, the sensors 110, or a combination thereof, in order to enhance the detection of observed activity.

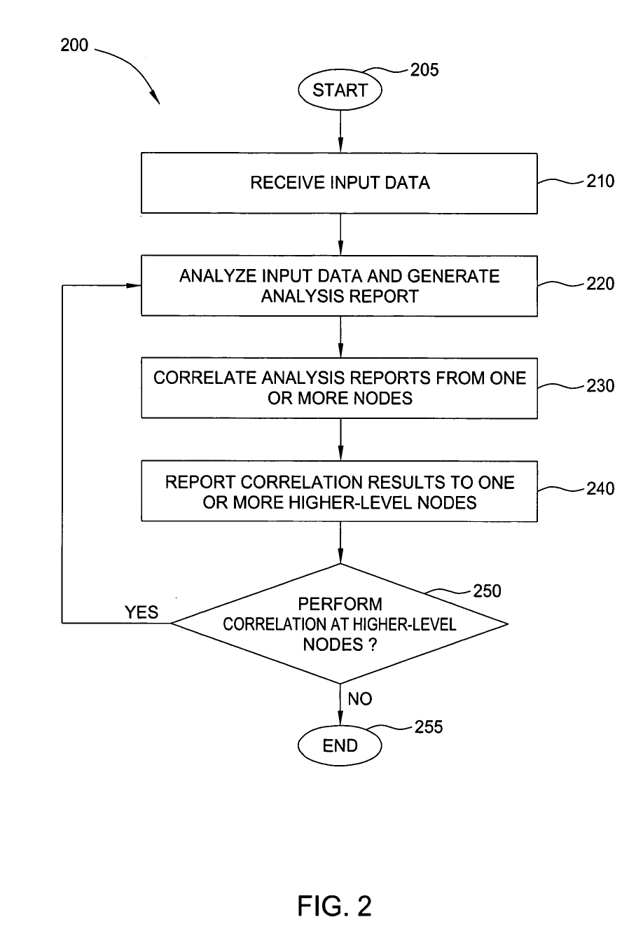

FIG. 2 is a flow diagram illustrating one embodiment of a method 200 for analyzing and correlating sensor results, according to the present invention. The method 200 may be executed at, for example, the nodes 120, 130 and/or 140 of the system 100.

The method 200 is initialized at step 205 and proceeds to step 210, where the method 200 receives input data. In one embodiment, the input data is at least one of raw sensor data (e.g., from a biological sensor array), reports from other nodes in the system, data items from a database of stored data, models and history, and pathogen models, among others. In one embodiment, the input data further includes supplemental input data. In one embodiment, the supplemental input data may be any one or more of symptoms experienced by a sample provider (e.g., headaches, nausea dizziness and the like) and the provider's vital signs (e.g., heart rate, blood pressure, breathing rate, temperature and the like), physical characteristics of the sample provider (e.g., gender, height, weight and the like), or any diagnosed disease state of the sample provider (e.g., the sample provider has been diagnosed with cancer, diabetes, etc.), among others. Such supplemental inputs, while not conclusive on their own, may provide an additional degree of confidence to a diagnosis or may help to identify trends among individuals sharing certain physiological similarities.

In one embodiment, information reported by the sensors 110 is disseminated to local nodes 120 via a subscription-based communications scheme. For example, the local nodes 120 may subscribe to receive reports produced by the sensors 110, which asynchronously disseminate reports to subscribing nodes as the reports are produced. Through subscription, sensors 110 are enabled to efficiently disseminate reports without the need for synchronous polling.

In step 220, the method 200 analyzes the input data and generates one or more analysis reports based on the analysis of the input data, e.g., in accordance with one or more methods described in further detail below. In step 230, the method 200 correlates an analysis report generated at a given node with one or more reports generated by other nodes. In one embodiment, the method 200 correlates analysis reports among nodes residing at a common hierarchical level (e.g., among all local nodes 120). Correlation of reports in step 230 helps to identify commonalities and anomalies among analysis reports generated by different nodes receiving input data from different sensors and analyzing different samples, e.g., samples of biological material submitted from multiple individuals and/or geographical regions.

In step 240, the method 200 reports the correlation results derived in step 230. In one embodiment, the method 200 reports the correlation results to at least one of a local administrator and other higher-level nodes in the system 100 (e.g., regional nodes 130 and/or global node 140). In another embodiment, the method 200 reports the correlation results to one or more lower-level nodes or sensors (e.g., sensors 110), so that the lower-level nodes or sensors may adjust their respective sensitivities to emerging global or other large-scale phenomena (e.g., by adjusting local models and/or expectations based on these emerging trends).

In step 250, the method 200 determines whether further correlation should be performed at the higher-level nodes. For example, regional nodes 130 may correlate initial correlation reports received from two or more local nodes 120, thereby enabling the identification of commonalities and anomalies for increasingly larger sources of input data (e.g., larger geographical or demographic areas). If the method 200 determines that further correlation is to be performed, the method 200 returns to step 220 and proceeds as described above, using the correlation reports received from the lower-level nodes as one form of input data. Alternatively, if the method 200 determines that further correlation is not necessary, the method 200 terminates in step 255.

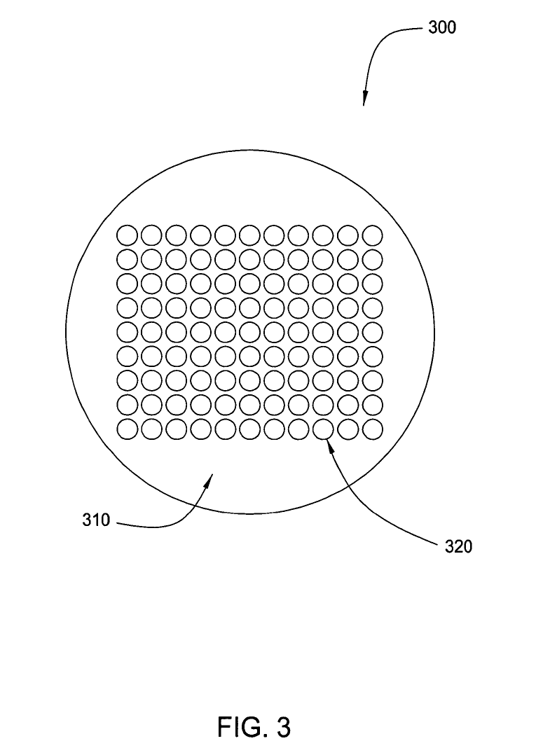

FIG. 3 is a plan view illustrating one embodiment of an array 300 of biological sensors 320 that may be adapted for use with the system illustrated in FIG. 1 (e.g., as sensors 110). In one embodiment, the array 300 comprises a substrate 310 upon which a plurality of biological sensors 320 are mounted. In one embodiment, one or more of the sensors 320 may be a pathogen sensor, a plasma protein sensor, a host ribonucleic acid (RNA) expression sensor, a complementary deoxyribonucleic acid (cDNA) sensor or an alternate type of plasma sensor, among others. In one embodiment, the sensors 320 are heterogeneous such that different sensors 320 are configured for analyzing different types of samples. For example, some sensors 320 may analyze blood, while other sensors 320 may analyze other liquid or aerosol samples.

The array 300 is configured to allow a sample of biological material (not shown) to be introduced, in a controlled environment, in a manner that exposes the sample to all of the sensors 320. Resultant interactions of the sensors 320 with the sample indicate the presence (or absence) of, for example, pathogens or toxic agents in the sample. These interactions may be observed using known devices such as optical density readers, fluorescence readers, electrical conductivity detectors, micro array readers and the like. In one embodiment, the interactions are analyzed in a manner that enables the identification of the particular sensor or sensors that produced each interaction or result.

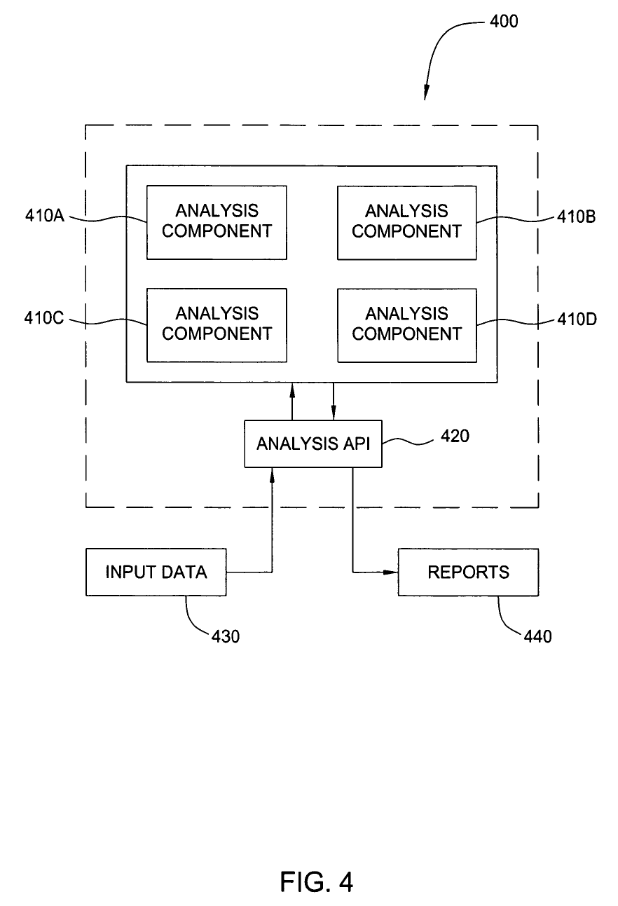

FIG. 4 is a schematic diagram illustrating one embodiment of a distributed correlation node 400 that may be adapted for use with the system illustrated in FIG. 1 (e.g., as nodes 120, 130 or 140). The correlation node 400 is generally adapted to receive input data (including biological sensor results, reports and/or supplemental data), analyze the input data (e.g., to confirm the presence of pathogens or toxic agents the samples or to identify commonalities at a reporting level), and report the results of the analysis, as described in further detail below. In one embodiment, the correlation node 400 comprises one or more analysis components 410a-410n (hereinafter collectively referred to as “analysis components 410”) and an Application Programmer's Interface (API) 420. Although the correlation node 400 is illustrated as comprising four analysis components 410, those skilled in the art will appreciate that any number of analysis components may be implemented, and additional analysis components may be dynamically added, deleted or modified as necessary.

The API 420 is enabled to receive input data 430 and to deliver the input data 430 to the analysis components 410 for analysis. During analysis, the API 420 is further enabled to interact with the analysis components 410 to facilitate communication between the analysis components 410, e.g., to enable the analysis components 410 to collaborate on the analysis of the input data 430, as described in further detail below. The API 420 is also configured to distribute analysis reports 440, e.g., to other nodes in the system 100 or to a system administrator. In one embodiment, the API 420 is also enabled to store input data for use by the analysis components 410 in future analyses. Alternatively, the analysis components 410 themselves may be enabled to store data.

In one embodiment, analysis components 410 are modules in which one or more software programs for performing biological data analysis and correlation are deployed. Analysis techniques that may be embodied in analysis components 410 include, without limitation, pattern recognition (e.g., as described in J. T. Tou and R. C. Gonzalez, “Pattern Recognition Principles”, Addison-Wesley 1974), competitive learning (e.g., as described in D. Rummelhart and D. Zipser, “Feature Discovery by Competitive Learning”, Parallel Distributed Processing, MIT Press, 1988), statistical analysis, adaptive learning, model-based reasoning, correlation, anomaly detection, hybrid systems (e.g., the Bayes system described in A. Valdes and K. Skinner, “Adaptive, Model-based Monitoring for Cyber Attack Detection”, Proc. Recent Advances in Intrusion Detection (RAID 2000), Toulouse, France, October 2000) and the like.

In one embodiment, one or more analysis components implement a pattern recognition or competitive learning technique that is capable of dynamically growing a new library of pattern classes (e.g., for patterns observed in an analyzed sample) if no currently defined pattern class is sufficiently similar to a new pattern observed in the sensor data 430, thereby enabling the discovery of a number of clusters of patterns into which the sensor data appears to be organized. In one embodiment, observed patterns may consist of anomalous sequences of numeric sensor data (e.g., spikes and troughs). In other embodiments, observed patterns consist of more complex patterns that indicate the presence of pathogens or toxic agents. Other hybrid systems and methods that may be deployed in analysis components 410 include those described in co-pending, commonly assigned U.S. patent application Ser. No. 09/653,066, filed Sep. 1, 2000 by Valdes et al., Ser. No. 09/711,323, filed Nov. 9, 2000 by Valdes et al., and Ser. No. 09/944,788, filed Aug. 31, 2001 by Valdes et al., all of which are herein incorporated by reference.

In one embodiment, rules for interpreting data analysis results can be derived from in-vitro studies, in-vivo studies, published literature (e.g., describing host responses to particular pathogens and/or toxic agents), or a combination thereof. Models may then be derived that enable rapid diagnosis of pathogens and/or toxic agents. In one embodiment, models are derived in accordance with the methods described in co-pending, commonly assigned U.S. patent application Ser. No. 09/855,458, filed May 15, 2001 by Lincoln et al. and Ser. No. 10/055,775, filed Jan. 23, 2002 by Eker et al. which are herein incorporated by reference.

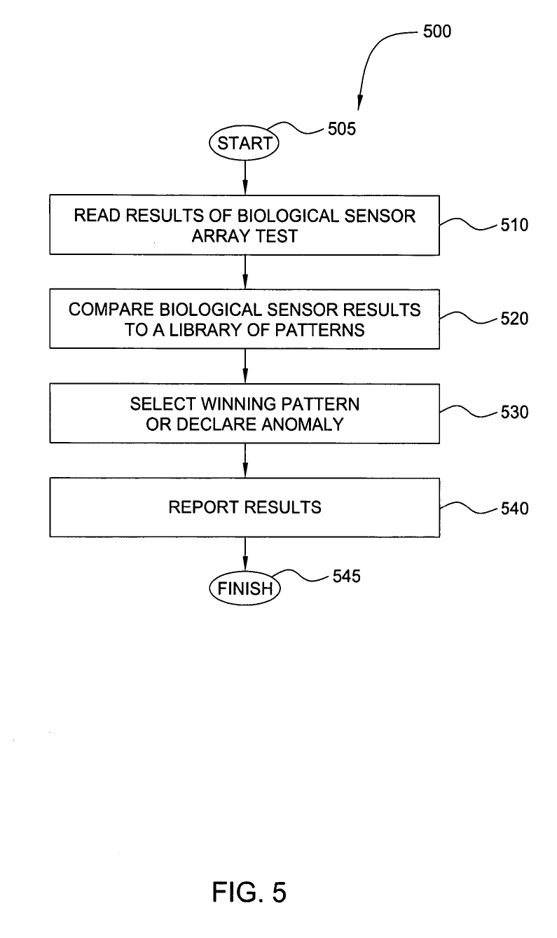

FIG. 5 is a flow diagram illustrating one embodiment of an adaptive learning method 500 that may be implemented in one or more analysis components 410 for the analysis of biological sensor data 430. The method 500 is initialized at step 505 and proceeds to step 510, where the method 500 reads results from a biological sensor array (e.g., array 300). In step 520, the method 500 compares the array results against a library of known data patterns. The library of patterns may initially be empty, or it may be seeded as described in further detail below. In one embodiment, if the observed pattern matches one or more stored patterns, or if a similarity (e.g., represented as a percentage likelihood of a match) exceeds a predefined threshold, the observed pattern is determined to belong to the class of the most similar stored pattern.

In one embodiment, the similarity between the observed pattern, X, and a k^{th} stored pattern, Eₖ, is evaluated by finding a value for K such that:
Sim(X,Eₖ)>Sim(X,Eₖ)∀k (EQN. 1)
where, if Sim(X, Eₖ) is greater than or equal to a predefined minimum match threshold, T_{match}, the method 500 determines the stored pattern Eₖ to be a match in step 530, or the “winner”. Alternatively, if Sim(X, Eₖ) is less than T_{match}, the method 500 inserts the observed pattern, X, into the library as a new pattern in step 530.

In one embodiment, the matching pattern may be adaptively modified by combining the pattern with the new (e.g., observed) pattern. In one embodiment, the degree of combination depends on the historical count of observations in the matching stored pattern. The historical count is exponentially decayed with a slow aging factor, and frequently occurring patterns are therefore less perturbed by combination with the new pattern. In one embodiment, the new pattern is combined with the stored pattern according to the following equation:

$${E}_{k} ← \frac{1}{{n}_{k} + 1} ( {n}_{k} {E}_{k} + X ) \qquad ( EQN . 2 )$$

where nₖ is the historical (possibly aged) count of occurrences of the stored pattern Eₖ.

In one embodiment, whether the method 500 determines that an anomaly exists (e.g., no “winning” pattern is defined) depends on the normalized probability of the closest matching pattern. In one embodiment, the anomaly score is the tail probability (e.g., the sum of the probabilities of all stored patterns that are as probable or less probable than the closest matching pattern). If the anomaly score is sufficiently close to zero (e.g., if the score is less than or equal to a predefined alert threshold Tₐₗₑᵣₜ, the method 500 determines that the observed pattern is an anomaly. In one embodiment, the method 500 evaluates an observed pattern for an anomaly according to the following relation, where Pr(Eₖ) is the historical probability of a stored pattern K:

$$Pr ( {E}_{k} ) = \frac{{n}_{k }}{{\sum }_{k}^{} {n}_{k}} \qquad ( EQN . 3 )$$

The historical tail probability, Tail_Pr(Eₖ), is calculated as:

$$Tail\_Pr ( {E}_{k} ) = {\sum }_{Pr ( {E}_{k} ) \geq Pr ( {E}_{j} )}^{} Pr ( {E}_{j} ) \qquad ( EQN . 4 )$$

If the historical tail probability, Tail_Pr(Eₖ) is less than or equal to the alert threshold, Tₐₗₑᵣₜ, the method 500 determines that the observed pattern is an anomaly.

In one embodiment, the method 500 tags all stored patterns in the library with a “trigger tag” (e.g., ALERT_IF_RARE, ALERT_ALWAYS, ALERT_NEVER, among others) in order to reduce the likelihood of initiating a false alarm when rare but innocuous sensor data triggers an anomaly. The tags also alert an observer to the detection of patterns that are potentially harmful, but are observed regularly enough that their observation would not necessarily trigger an anomaly alert. In one embodiment, pure anomaly detection is equated with the assignment of a tag that only triggers an alert if the observed pattern is rare (e.g., ALERT_IF_RARE).

In one embodiment, as mentioned above, the pattern library is seeded so that patterns corresponding to rare but benign (or at least not representing a pattern of urgent concern) conditions would have a tag that never generates an alert (e.g., ALERT_NEVER). Conversely, patterns corresponding to serious conditions that are not necessarily considered rare at the anomaly threshold may be tagged such that an alert is always generated (e.g., ALERT_ALWAYS).

In step 540, the method 500 reports (e.g., to a higher-level node in the system 100) its findings based on the analysis of the sensor array results, and in step 545 the method 500 terminates.

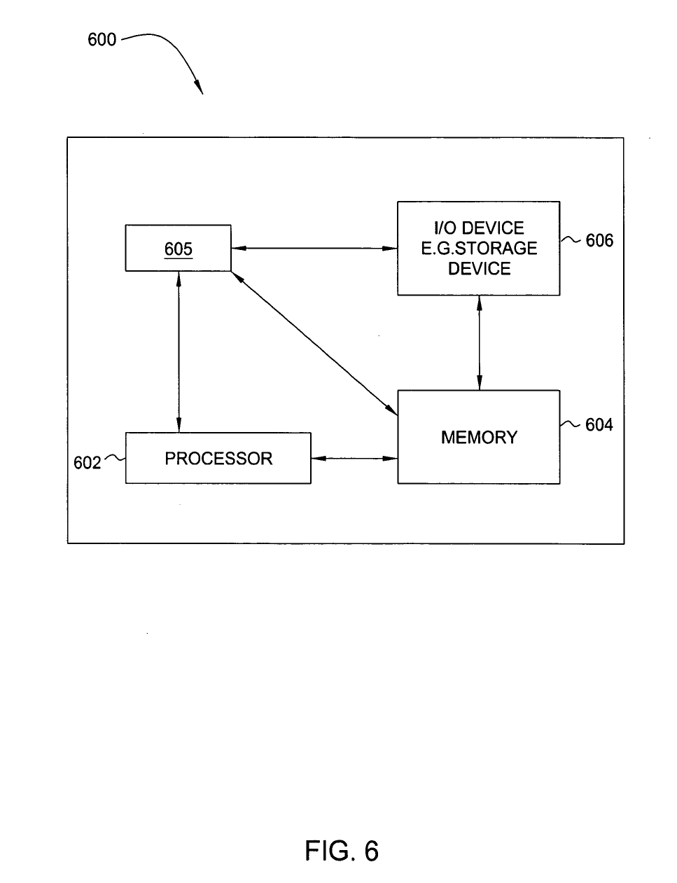

FIG. 6 is a high level block diagram of the present method for correlation of biological sensors that is implemented using a general purpose computing device 600. In one embodiment, a general purpose computing device 600 comprises a processor 602, a memory 604, a sensor analysis and correlation mouse, a modem, and the like. In one embodiment, at least one I/O device is a storage device (e.g., a disk drive, an optical disk drive, a floppy disk drive). It should be understood that the sensor analysis and correlation module 605 can be implemented as a physical device or subsystem that is coupled to a processor through a communication channel.

Alternatively, sensor analysis and correlation module 605 can be represented by one or more software applications (or even a combination of software and hardware, e.g., using Application Specific Integrated Circuits (ASIC)), where the software is loaded from a storage medium (e.g., I/O devices 606) and operated by the processor 602 in the memory 604 of the general purpose computing device 600. Thus, in one embodiment, the sensor analysis and correlation module 605 for analyzing and correlating biological sensor data described herein with reference to the preceding Figures can be stored on a computer readable medium or carrier (e.g., RAM, magnetic or optical drive or diskette, and the like).

In one embodiment, the method and apparatus described herein may be employed to build individual patient models, e.g., if a patient submits samples for analysis on multiple occasions. For example, the present method and apparatus may be applied to track variations in the RNA expression levels in an individual's white blood cells (e.g., due to disease, aging or other stresses), thereby enabling more accurate diagnoses in individual patients. Furthermore, those skilled in the art will appreciate that the present system and method may be applied to the analysis and correlation of any type of data, including non-communicable disease data or other health information, and is not limited strictly to the analysis and correlation of biological data.

Thus, the present invention represents a significant advancement in the field of pathogen and toxic agent detection. A method and apparatus are provided that enable rapid detection and identification of pathogens and toxic agents within a biological sample. Moreover, the method and apparatus enable sample analysis results to be correlated among multiple sources, facilitating the timely identification of biological trends, e.g., fast-spreading illnesses and/or conditions prevalent within certain demographics.

Although various embodiments which incorporate the teachings of the present invention have been shown and described in detail herein, those skilled in the art can readily devise many other varied embodiments that still incorporate these teachings.

What is claimed is:

1. A method for correlating biological data over a broad domain, the method comprising:
receiving data relating to at least two samples of biological material, said at least two samples originating at two different regions of said broad domain; and
correlating said data to produce a domain-wide view of said biological data.

2. The method of claim 1, wherein said data comprises at least one of: raw biological sensor data, correlated data from another lower-level source, correlated data from another high-level source, correlated data from another common-level source, data from a source outside said domain, a stored data item, a stored data history, a stored pathogen model and supplemental data related to a provider of said biological material.

3. The method of claim 2, wherein said supplemental data is at least one of: one or more symptoms experienced by said provider, said provider's vital signs, said provider's physical characteristics and any diagnosed disease state of said sample provider.

4. The method of claim 1, wherein said data is received from at least one of: a biological sensor, a lower-level data correlation source, a higher-level data correlation source, a common-level data correlation source and a source outside said domain.

5. The method of claim 1, further comprising:
generating a report based on said correlation.

6. The method of claim 5, wherein said report is provided to at least one of: a domain administrator, a higher-level correlation source, a lower-level correlation source, a common-level correlation source and a sensor.

7. The method of claim 1, wherein said broad domain is at least one of: a broad geographic domain and a broad demographic domain.

8. The method of claim 1, wherein said correlation comprises:
analyzing said data to determine the presence or absence of pathogens or toxic agents in said at least two samples of biological material; and
identifying commonalities in said analyzed data.

9. The method of claim 8, wherein said analysis is performed in accordance with at least one of: pattern recognition, competitive learning, statistical analysis, adaptive learning, model-based reasoning, correlation, anomaly detection and hybrid systems.

10. The method of claim 9, wherein at least one of said pattern recognition and competitive learning techniques is adapted to grow a new library of pattern classes corresponding to at least one newly observed pattern in said analyzed data.

11. A computer readable medium containing an executable program for correlating biological data over a broad domain, where the program performs the steps of:
receiving data relating to at least two samples of biological material, said at least two samples originating at two different regions of said broad domain; and
correlating said data to produce a domain-wide view of said biological data.

12. The computer readable medium of claim 11, wherein said data comprises at least one of: raw biological sensor data, correlated data from another lower-level source, correlated data from another high-level source, correlated data from another common-level source, data from a source outside said domain, a stored data item, a stored data history, a stored pathogen model and supplemental data related to a provider of said biological material.

13. The computer readable medium of claim 12, wherein said supplemental data is at least one of: one or more symptoms experienced by said provider, said provider's vital signs, said provider's physical characteristics and any diagnosed disease state of said sample provider.

14. The computer readable medium of claim 11, wherein said data is received from at least one of: a biological sensor, a lower-level data correlation source, a higher-level data correlation source, a common-level data correlation source and a source outside said domain.

15. The computer readable medium of claim 11, further comprising:
generating a report based on said correlation.

16. The computer readable medium of claim 15, wherein said report is provided to at least one of: a domain administrator, a higher-level correlation source, a lower-level correlation source, a common-level correlation source and a sensor.

17. The computer readable medium of claim 11, wherein said broad domain is at least one of: a broad geographic domain and a broad demographic domain.

18. The computer readable medium of claim 11, wherein said correlation comprises:
analyzing said data to determine the presence or absence of pathogens or toxic agents in said at least two samples of biological material; and
identifying commonalities in said analyzed data.

19. The computer readable medium of claim 18, wherein said analysis is performed in accordance with at least one of: pattern recognition, competitive learning, statistical analysis, adaptive learning, model-based reasoning, correlation, anomaly detection and hybrid systems.

20. The computer readable medium of claim 19, wherein at least one of said pattern recognition and competitive learning techniques is adapted to grow a new library of pattern classes corresponding to at least one newly observed pattern in said analyzed data.

21. Apparatus for correlating biological data over a broad domain, the apparatus comprising:
means for receiving data relating to at least two samples of biological material, said at least two samples originating at two different regions of said broad domain; and
means for correlating said data to produce a domain-wide view of said biological data.

22. A system for correlating biological data over a broad domain, comprising:
a plurality of biological sensors distributed throughout said broad domain and adapted to analyze biological or environmental material to produce sensor results;
a first plurality of correlation nodes, each of said first plurality of correlation nodes being adapted to receive said sensor results from at least one of said plurality of biological sensors and to process said sensor results to produce a first set of correlated results; and
at least one global correlation node adapted to receive a first set of correlated results from at least two of said first plurality of correlation nodes and to process said first sets of correlated results to produce a second set of correlated results providing a domain-wide view of said biological data.

23. The system of claim 22, further comprising:
at least one intermediate plurality of correlation nodes adapted to receive and correlate a first set of correlated results from at least two of said first plurality of correlation nodes, to produce an intermediate set of correlated results, and to deliver said intermediate set of correlated results to at least one of said at least one global correlation node and said first plurality of correlation nodes.

24. The system of claim 22, wherein at least one of said first plurality of correlation nodes and said at least one global correlation node is adapted to reconfigure system parameters of other nodes.

25. The system of claim 22, wherein at least one of said first plurality of correlation nodes and said at least one global correlation node is adapted to interface with nodes outside of said broad domain.

26. The system of claim 22, wherein at least one of said first plurality of correlation nodes and said at least one global correlation node is adapted to report activity within said broad domain to at least one of a domain administrator, to other correlation nodes and to said plurality of biological sensors.

27. The system of claim 22, wherein a peer-to-peer relationship exists between said first plurality of correlation nodes and said at least one global correlation node.
